(19) United States
(12) Patent Application Publication
(10) Pub. No.: US 2014/0304632 A1
(43) Pub. Date: Oct. 9, 2014

(54) SMART DEVICE FOR CONVENIENT GRAPHIC OBJECT ARRANGEMENT AND METHOD OF GRAPHIC OBJECT ARRANGEMENT

(71) Applicant: Pantech Co., Ltd., Seoul (KR)

(72) Inventor: Jin-Woo RYU, Goyang-si (KR)

(73) Assignee: Pantech Co., Ltd., Seoul (KR)

(21) Appl. No.: 14/227,424

(22) Filed: Mar. 27, 2014

(30) Foreign Application Priority Data
Apr. 4, 2013 (KR) 10-2013-0037055

(51) Int. Cl. G06F 3/0481; G06F 3/0482

(52) U.S. Cl. CPC G06F 3/04817; G06F 3/0482
USPC 715/765

(57) ABSTRACT

A smart device and a method are disclosed. The method utilizes a processor for arranging a graphic object on a desktop, the method includes: disposing a launcher icon on a target position of the desktop; checking, with the processor, an application data table to retrieve icons associated with an application; selecting the launcher icon as a selected icon when the retrieved icons include a single icon and selecting one of the retrieved icons as a selected icon when the retrieved icons include a plurality of icons; and arranging the selected icon in the target position.

### CROSS-REFERENCE TO RELATED APPLICATION

This application claims priority from and the benefit under 35 U.S.C. §119(a) of a Korean Patent Application No. 10-2013-0037055, filed on Apr. 4, 2013, the entire disclosure of which is incorporated herein by reference for all purposes.

### BACKGROUND

1. Field

The following description relates to a User Interface (UI) for arranging graphic objects of an application on a desktop, and more particularly, to a user interface for arranging respective graphic objects when various types of graphic objects having different functions, such as, a launcher icon, a widget, and a shortcut are present in an application.

2. Discussion of the Background

In general, smart devices, such as, a smart phone, allow a user to arrange graphic objects of applications on a desktop with a user interface. However, an application can present a plurality of graphic objects rather than a single graphic object according to functions provided by the plurality of graphic objects of the application. For example, a setting application of ANDROID has various types of graphic objects, such as, a launcher icon, a widget, and a shortcut. It is well known that such graphic objects have different functions. From the viewpoint of the user, when the plurality of graphic objects is present in one application, the user arranges the graphic objects having a desired function on the desktop to use them. In addition, it is possible to arrange two or more graphic objects of the plurality of graphic objects with respect to one application on the desktop.

A user who is not familiar with smart device usage is unlikely to realize that a plurality of functions and graphic objects are present in one application. For example, the launcher icon for an application is well known and is widely used, but many people do not know about and thus fail to use a widget function or a shortcut function for the application. Even when the user is well aware of such functions, it is difficult to recognize that an arbitrary application uses different graphic objects for the shortcut function or the widget function in addition to the launcher icon through an existing user interface. Further, the existing user interface provides different menu trees for arranging the launcher icon, the widget, and the shortcut on the desktop. Accordingly, from the viewpoint of the user, it is inconvenient to access different menus when the user wishes to arrange two or more graphic objects with respect to one application.

FIG. 1A and FIG. 1B illustrate a method of arranging a launcher icon on an ANDROID system.

As illustrated in screen (a) in FIG. 1A, the user may arrange the launcher icon in a desired position on the desktop by performing a drag-and-drop operation while pressing and holding the launcher icon to be arranged on the desktop. The user presses and holds a launcher icon to be arranged in a graphic object list called ALL APPS and the desktop switches to screen (b) illustrated in FIG. 1A. After switching to the desktop screen (b), the user arranges the launcher icon by dragging it to a desired position on the desktop as illustrated in screens (c) (FIG. 1A), (d) (FIG. 1B) and (e) (FIG. 1B). The user then releases the launcher icon, and the launcher icon is thereby arranged in the corresponding position.

FIG. 2A and FIG. 2B illustrate a method of arranging a widget on an ANDROID system.

The user may select a widget in a widget tray as illustrated in screen (b) in FIG. 2A by pressing and holding a predetermined position or by pressing a menu key as illustrated in screen (a) in FIG. 2A. After the user selects a desired widget as illustrated in screen (c) in FIG. 2A, the user performs a drag-and-drop operation as illustrated in screens (d), (e), and (f) in FIG. 2B and arranges the widget in a desired position on the desktop.

FIG. 3A and FIG. 3B illustrate a method of arranging a shortcut on an ANDROID system.

The user may select a shortcut in a widget tray as illustrated in screen (b) in FIG. 3A by pressing and holding a predetermined position or by pressing a menu key as illustrated in screen (a) in FIG. 3A. The user selects a desired shortcut and arranges the shortcut in a desired position on the desktop as illustrated in screen (c) in FIG. 3A. When the user selects an item to have a shortcut function as illustrated in screen (d) in FIG. 3B, the shortcut corresponding to the selected item is arranged on the desktop as illustrated in screens (e) and (f) in FIG. 3B.

As described above, since graphic objects are necessarily arranged on the desktop through different menu trees, it is inconvenient for the user. That is, user convenience is not taken into account in the UI for the existing graphic object arrangement.

### SUMMARY

Exemplary embodiments of the present invention provide a user interface for arranging respective graphic objects when various types of graphic objects having different functions, such as, a launcher icon, a widget, and a shortcut are present in an application.

Additional features of the invention will be set forth in the description that follows, and in part will be apparent from the description, or may be learned by practice of the invention.

An exemplary embodiment of the present invention discloses a method, utilizing a processor, for arranging a graphic object on a desktop, the method including: disposing a launcher icon on a target position of the desktop; checking, with the processor, an application data table to retrieve icons associated with an application; selecting the launcher icon as a selected icon when the retrieved icons include a single icon and selecting one of the retrieved icons as a selected icon when the retrieved icons include a plurality of icons; and arranging the selected icon in the target position.

An exemplary embodiment of the present invention discloses a smart device to arrange a graphic object on a desktop, the smart device including: a storage including an application data table including icons associated with an application; and a user interface configuring unit configured to dispose a launcher icon on a target position of the desktop, configured to check an application data table to retrieve icons associated with an application, configured to select the launcher icon as a selected icon when the retrieved icons include a single icon and configured to select one of the retrieved icons as a selected icon when the retrieved icons include a plurality of icons, and configured to arrange the selected icon in the target position.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A and FIG. 1B illustrate a method of arranging a launcher icon on a related desktop.

FIG. 2A and FIG. 2B illustrate a method of arranging a widget on a related desktop.

FIG. 3A and FIG. 3B illustrate a method of arranging a shortcut on a related desktop.

FIG. 4 illustrates a block diagram of a smart device for graphic object arrangement according to exemplary embodiments of the invention.

FIG. 5 illustrates an ANDROID OS layer configuration for graphic object arrangement according to exemplary embodiments of the invention.

FIG. 6 is a pre-processing flowchart for graphic object arrangement according to exemplary embodiments of the invention.

FIG. 7 illustrates an application list screen according to exemplary embodiments of the invention.

FIG. 8 illustrates an intent filter according to exemplary embodiments of the invention.

FIG. 9 illustrates a flowchart of graphic object arrangement according to exemplary embodiments of the invention.

FIG. 10A, FIG. 10B and FIG. 10C illustrate a graphic object arrangement UI according to exemplary embodiments of the invention.

FIG. 11 illustrates a flowchart of a graphic object replacement according to exemplary embodiments of the invention.

FIG. 12A and FIG. 12B illustrate a graphic object replacement UI according to exemplary embodiments of the invention.

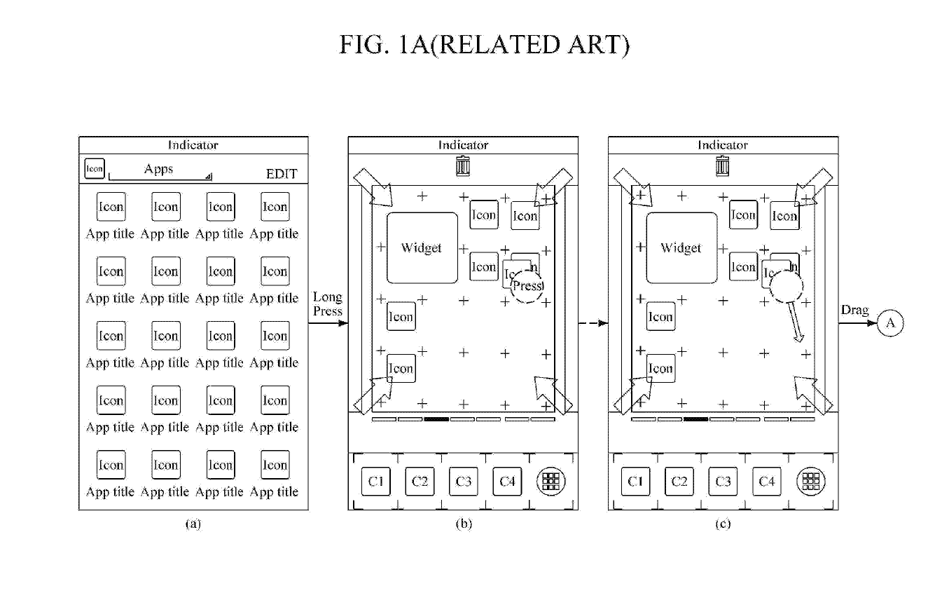

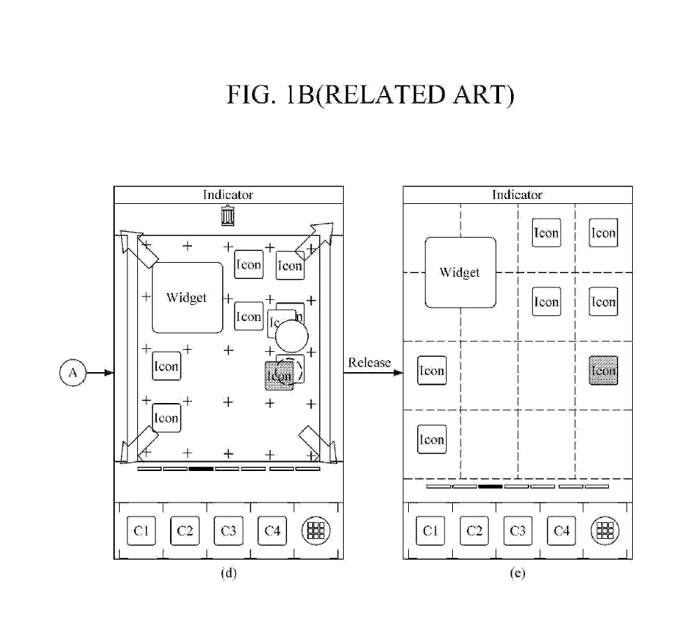

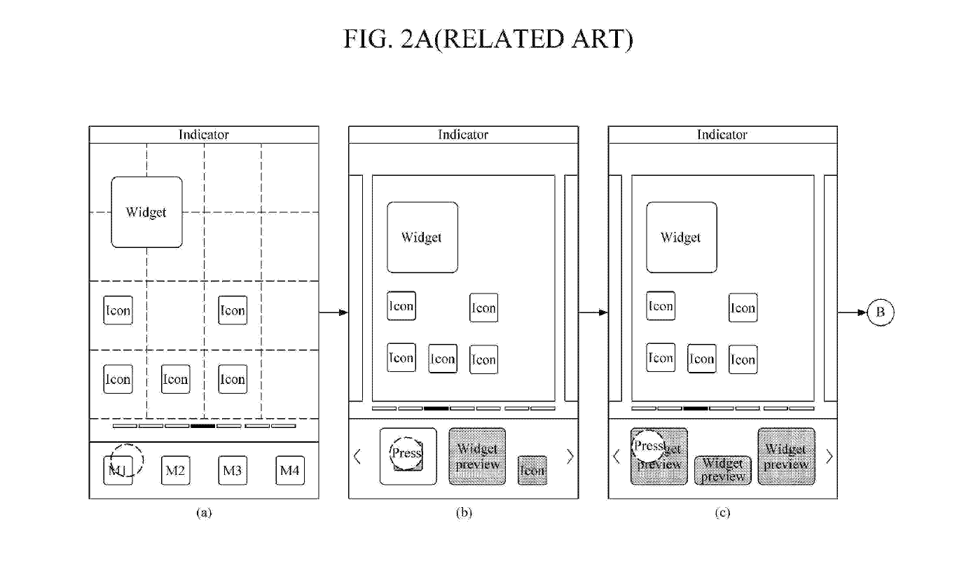

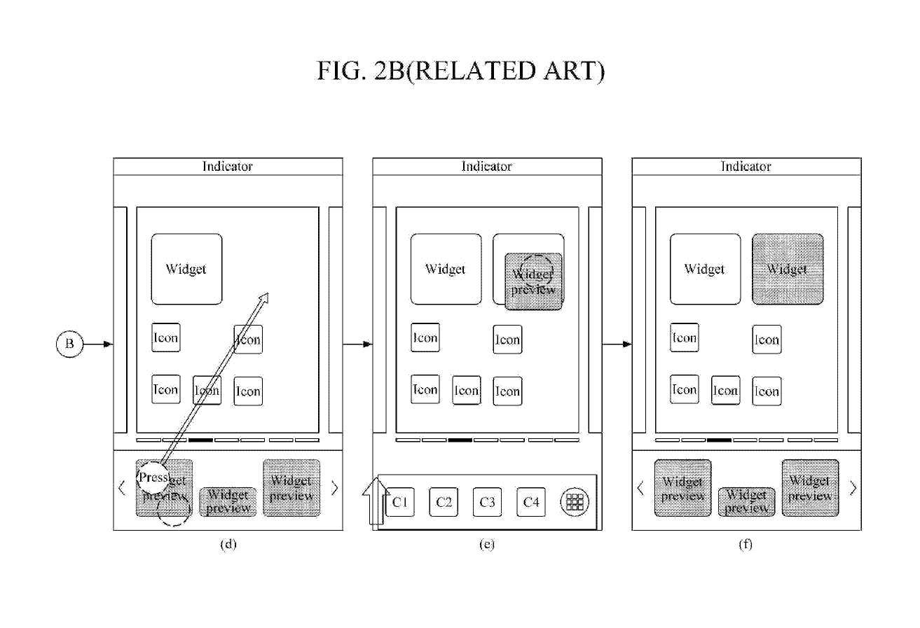

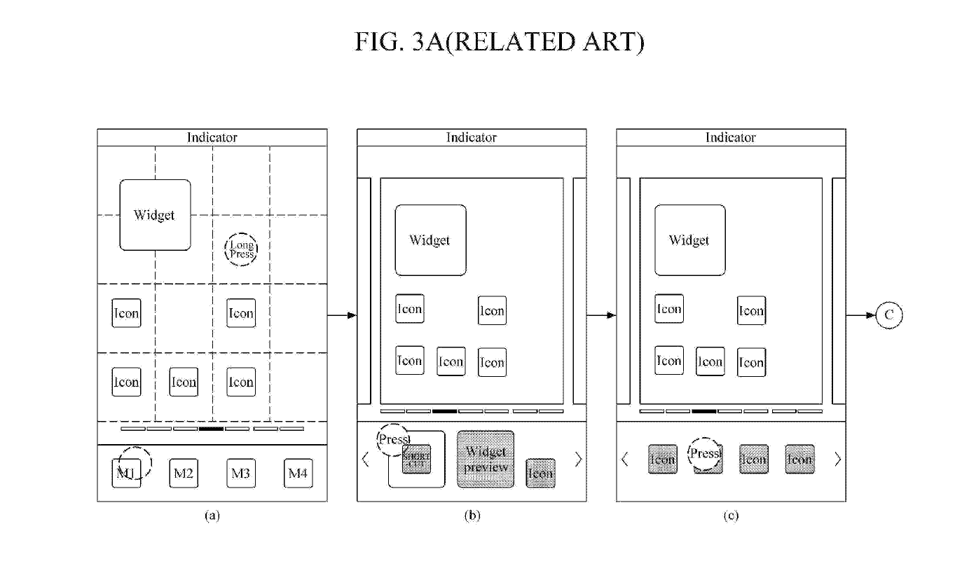

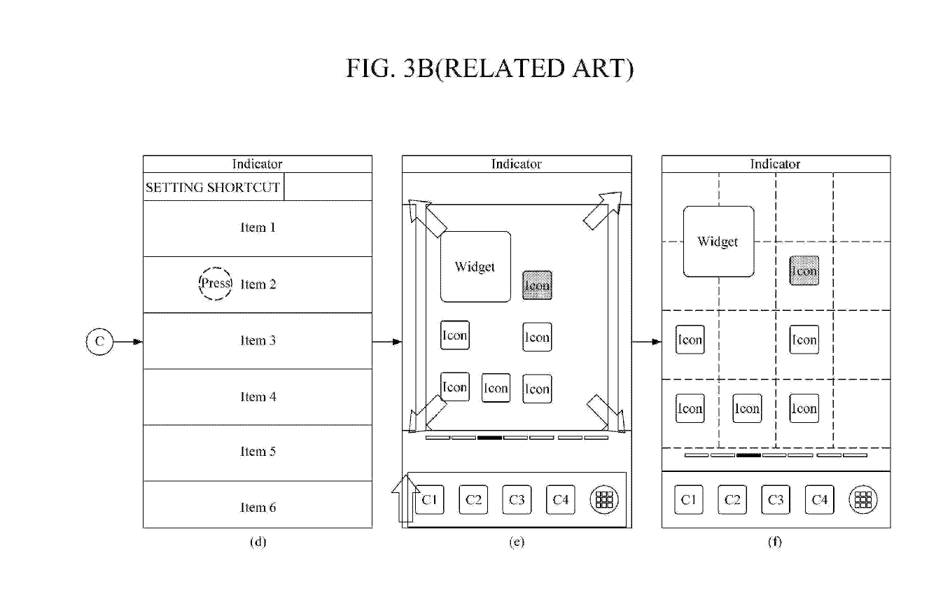

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions and constructions may be omitted for increased clarity and conciseness.

It will be understood that when an element is referred to as being “connected to” another element, it can be directly connected to the other element, or intervening elements may be present.

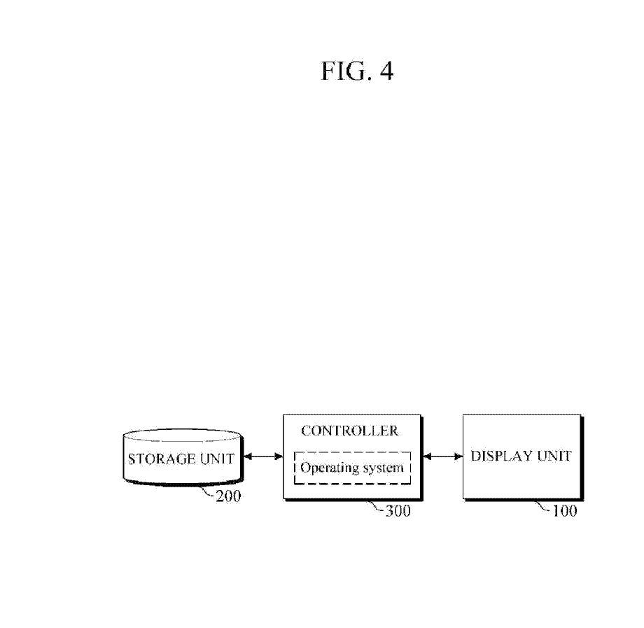

FIG. 4 illustrates a block diagram of a smart device for graphic object arrangement according to exemplary embodiments of the invention.

Examples of smart devices include a computer, a smart phone, and a smart pad. As illustrated in FIG. 4, the smart device includes a display unit 100, a storage unit 200 and a controller 300. The display unit 100 may be a liquid crystal display (LCD) or include a touch panel used for a touch input of a user. The storage unit 200 may be a non-volatile memory that stores graphic object type information based on application-specific attributes. The graphic object may refer to a launcher icon, a widget, or a shortcut. The controller 300 may include one or more control chips used for overall control of the smart device.

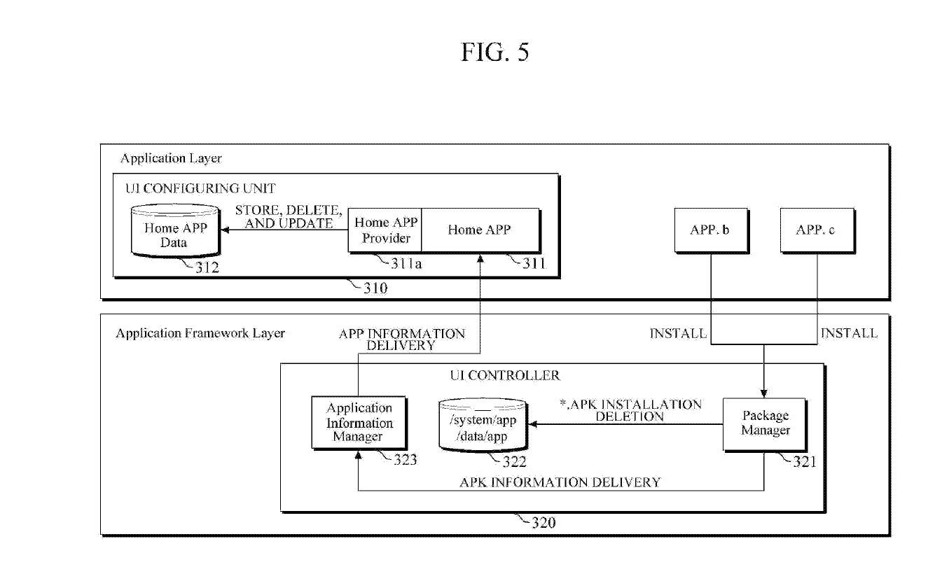

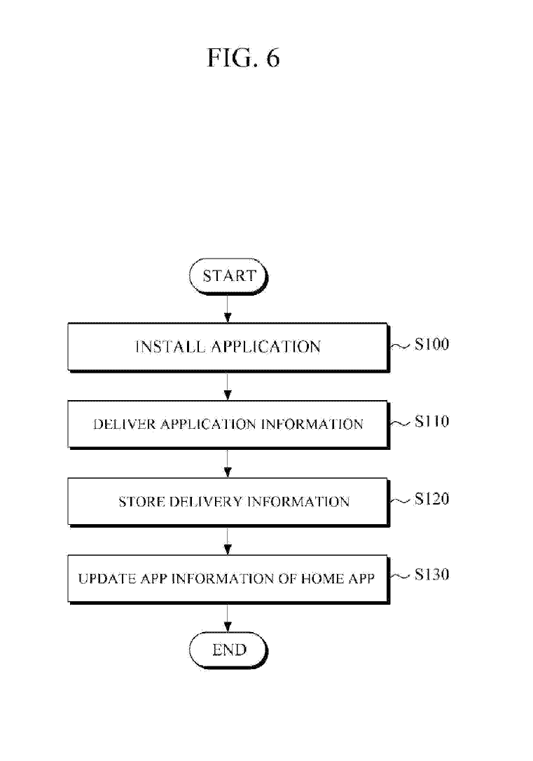

FIG. 5 illustrates an ANDROID OS layer configuration for graphic object arrangement according to exemplary embodiments of the invention.

First, although convenient graphic object arrangement is exemplified only in ANDROID OS in FIG. 5, aspects of the invention is not limited thereto. Methods of convenient graphic object arrangement according to the invention may be implemented in any operating system in which an application supports a plurality of graphic objects. A UI configuring unit 310 is included in an application layer and an application controller 320 is included in an application framework layer. A home application 311 of the UI configuring unit 310 manages a list of applications (programs) installed in the smart device. The list of applications can include all applications installed in the smart device. The UI configuring unit 310 can include a home application provider 311a in order to manage application-specific attributes through a home application data database (DB) 312. In DB 312, as an attribute, at least one of a launcher, a widget, and a shortcut may be exemplified. Hereinafter, these three attributes are assumed as attributes that may be held in the application. However, this is only for convenience of description, and attributes of the application may be diverse.

A package manager 321 of the application controller 320 installs new applications and deletes installed applications in an application DB 322. In addition, the package manager 321 delivers application information to an application information manager 323 for an attribute management of newly installed applications. The application information manager 323 determines which types of attributes among a launcher, a widget, and a shortcut are included in the corresponding application based on the delivered application information, and delivers the determination result to the home application 311.

FIG. 6 is a pre-processing flowchart for graphic object arrangement according to exemplary embodiments of the invention.

The package manager 321 installs a new application (App.a) in operation S100 and delivers information on the newly installed application to the application information manager 323 in operation S110. The application information manager 323 determines which types of attributes among a launcher, a widget, and a shortcut are included in the corresponding application based on the delivered application information, and delivers the attribute information according to the determination result to the home application 311. Therefore, a provider of the home application 311 allows the attribute information on the corresponding application to be stored in the home application data DB 312 in operation S120. An exemplary application data table stored in the home application data DB 312 is illustrated in Table 1.

TABLE 1

| App name | Launcher | Widget | Shortcut |
|---|---|---|---|
| com.android.app.Settings | True | True | True |
| app.b | True | False | False |
| app.c | True | True | False |
| app.d | True | False | True |

“App name” is unique information on an application and all applications have a unique package name. “Launcher” represents whether a corresponding application has a launching attribute. “Widget” represents whether a corresponding application has a widget attribute. “Shortcut” represents whether a corresponding application has a shortcut attribute. As shown in Table 1, a setting application (com.android.app.Settings) has all functions of a launcher, a widget, and a shortcut. “app.b” has only a launcher function. “app.c” has functions of a launcher and a widget, and “app.d” has functions of a launcher and a shortcut. The home application data DB 312 is managed such that corresponding attribute information reflects application installation, application update, and application deletion.

Attribute information on the new application is stored in the home application data DB 312. The home application 311 updates information on an application list graphic object in operation S130. That is, the home application 311 adds graphic objects of the newly installed application to graphic objects when configuring the current application list. Graphic objects configuring the application list may be graphic objects having a specific attribute. For example, the specific attribute may refer to a launcher. Accordingly, the application list is configured with launcher icons of the applications and the launcher icons may be defined as basic graphic objects of the applications.

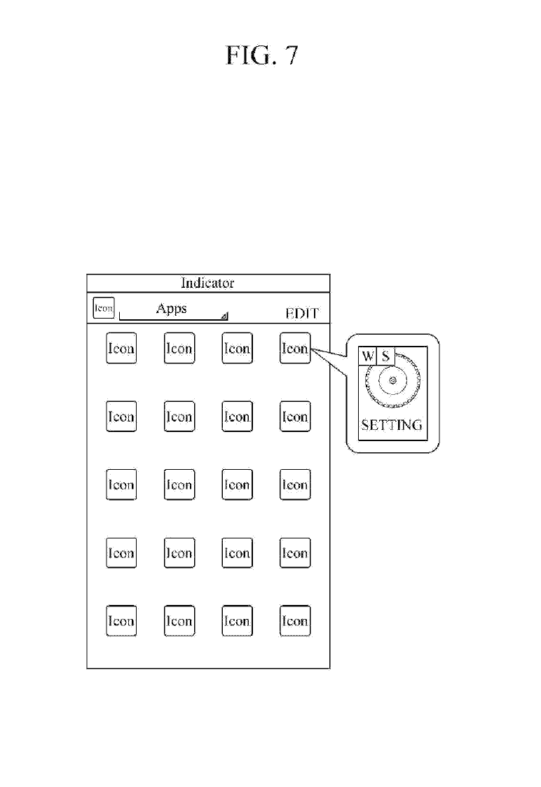

The home application 311 may represent a presence of different types of graphic objects with respect to the corresponding application on the graphic object configuring the application list. For example, when an arbitrary application has all functions of a launcher, a widget, and a shortcut, the presence of functions of a widget and a shortcut is represented on the launcher icon of the corresponding application in the application list screen, and may be represented by graphic information signifying an icon or graphic object type as exemplified in FIG. 7. As illustrated in FIG. 7, when a launcher icon of the setting application among launcher icons configuring the application list screen is used as an example, it is possible to inform the user of different functions by representing graphic information having “w” and “s” on the setting icon. Note that “w” indicates the presence of a widget function and “s” indicates the presence of a shortcut function. Therefore, the user may intuitively recognize the presence of a widget and a shortcut in addition to the setting icon of the setting application.

Hereinafter, an object and a component used to implement a pre-processing method for convenient graphic object arrangement will be described with reference to FIGS. 5 and 6.

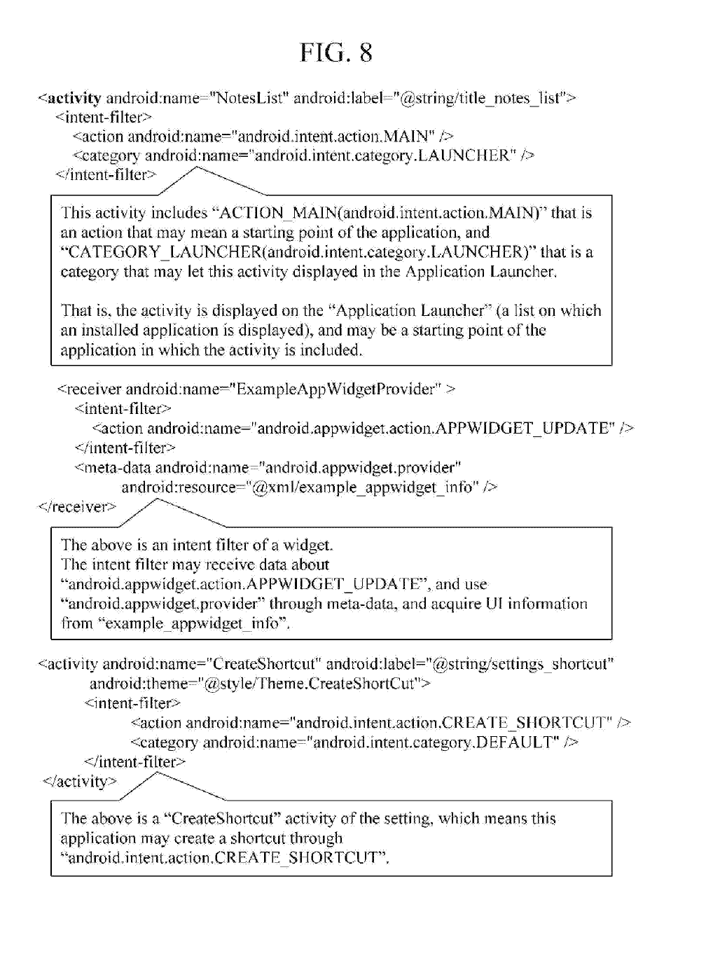

FIG. 8 illustrates an intent filter according to exemplary embodiments of the invention.

“Intent” is an asynchronous message mechanism used in an ANDROID operating system. Core components of ANDROID applications, for example, activities, services, broadcasts, and broadcast receivers, are activated through such intent. That is, the intent itself includes an abstract description of an operation to be performed and the application is executed using such information.

“Component name” is the name of the component that should be handled through the intent and is a combination of a component name and a specific class name of the class. A designated component name is sent to the intent and then is delivered to the designated class to be executed.

“Action” is a string naming the action to be performed and activates specific actions through pre-defined constants. For example, ACTION_CALL activates an action of “initiate a phone call,” and ACTION_EDIT activates an action of “display data for the user to edit.”

“Category” is a string containing additional information about the kind of component that should handle the intent. For example, CATEGORY_HOME indicates “the activity displays the home screen” and <category android:name=“android.intent.category.LAUNCHER”/> is an activity capable of arranging the graphic object.

“Data” refers the uniform resource identifier (URI) of the data to be acted on and the MIME type of that data. For example, if the action is ACTION_EDIT, the data field would contain the URI of the document to be displayed for editing. If the action is ACTION_CALL, the data field would be a tel:URI with the number to call.

“Intent filter” describes a capability of the component, that is, a set of intents that the component is willing to receive. Intent filters are described in the AndroidManifest.xml file and filtering fields mainly include the action, category, and data as described-above.

“Action filter” tests that the action in the intent matches the action defined in the filter. To pass this test, the action in the intent must match the action defined in the intent filter. If the action is not defined in the intent, it is possible to pass the action filter.

TABLE 2

| Action defined in intent | Action defined intent filter | Result |
|---|---|---|
| Intent.ACTION_VIEW | Android.intent.action.VIEW | Pass |
| Intent.ACTION_VIEW | Android.intent.action.EDIT | Fail |
| None | Any action | Pass |

“Category filter” tests that the category field in the intent matches the category defined in the filter. If the action is not defined, it is possible to pass the action filter, but it is not possible to pass the category filter. Therefore, in creating an implicit intent, if categories are not added, CATEGORY-DEFAULT(android.intent.category.DEFAULT) is automatically added. Therefore, in order to receive the intent in which no particular categories are added, CATEGORY_DEFAULT needs to be added in the category filter.

TABLE 3

| Category of intent | Category of intent filter | Result |
|---|---|---|
| Intent.CATEGORY_DEFAULT | None | Fail |
| Intent.CATEGORY_DEFAULT | Android.intent.category.DEFAULT | Pass |

“Data filter” tests data and types in the intent. Data test is divided into a test in which the URI of the data is examined and a test in which the type (MIME type) of the data is examined. The parts examining the URI of the data examine the URI of the data by segmenting. The structure of the URI is as follows: scheme://host:port/path

For example, if http://google.com is segmented by each attribute, the scheme is “http” and the host is “google.com.”

type(mimeType) is used to filter the type of data. Exemplary mimeType definitions are as follows:

<data android:mimeType =“video/mpeg” android:scheme=“http”>
<data android:mimeType =“audio/*” android:scheme=“http”>

mimeType may be defined as the format as above, and defined as a main category or subcategory of the main category. For example, in a case of video/mpeg mimeType, video serves as a main category and mpeg serves as a subcategory. In the subcategory, a wildcard character (*) is used to allow all formats with the corresponding character. In such a manner, with interpretation of the first <data> filter, it is found that the intent of “video data of mpeg type having http scheme” is allowed, and with interpretation of the second <data> filter, it is found that the intent of “all audio data having http scheme” is allowed.

For reference, an example of the intent filter is illustrated in FIG. 8. For example, FIG. 8 illustrates an activity “ACTION_MAIN(android.intent.action.MAIN)” that is an action that may mean a starting point of the application, and a “CATEGORY LAUNCHER(android.intent.category.LAUNCHER)” that is a category that may let this activity be displayed in the Application Launcher. That is, the activity is displayed on the “Application Launcher” (a list on which an installed application is displayed), and may be a starting point of the application in which the activity is included. FIG. 8 also illustrates an intent filter of a widget. The intent filter may receive data about “android.appwidget.action.APPWIDGET UPDATE”, and use “android.appwidget.provider” through meta-data, and acquire Ul information from “example_appwidget_info”. FIG. 8 also illustrates a “Create Shortcut” activity of the setting, which indicates that this application may create a shortcut through “android.intent.action.CREATE SHORTCUT”.

Explicit intents designate the target component by name. Since component names would generally not be known to developers of other applications, explicit intents are typically used for starting a subordinate service or application or launching a sister activity. The explicit intent is always delivered to the designated target regardless of the intent filter. An example of the explicit intent is given below:

mSendIntent = new Intent(Intent.ACTION_MAIN);
mSendIntent.addCategory(“android.intent.category.LAUNCHER);
mSendIntent.setClassName(“com.pantech.app.video”,
“com.pantech.app.video.videogate.VideoGate”));

As above, the target is explicitly named by designating the class name.

An “implicit intent” does not name a target. Therefore, a designated intent is managed by the intent filter described above and is used to activate other applications. An example of the implicit intent is given below:

Intent cameraIntent = new Intent(MediaStore.ACTION_IMAGE_
CAPTURE);
startActivityForResult(cameraIntent,CAMERA);

With a description of the action, it is possible to call all components having corresponding action in the intent filter.

“Package manager” parses an XML file, such as, an androidmanifest.xml file, of the corresponding file in installed Application Package (apk) files by searching an apk installation path, for example, /system/app, /data/app on ANDROID platform, when the device is firstly executed. Information on, for example, a variety of authorities and intent filters defined in apk is collected so as to be managed in a memory. In addition, the package manager receives broadcast intents, which are generated when new applications are added or deleted. The package manager updates and deletes its own address book.

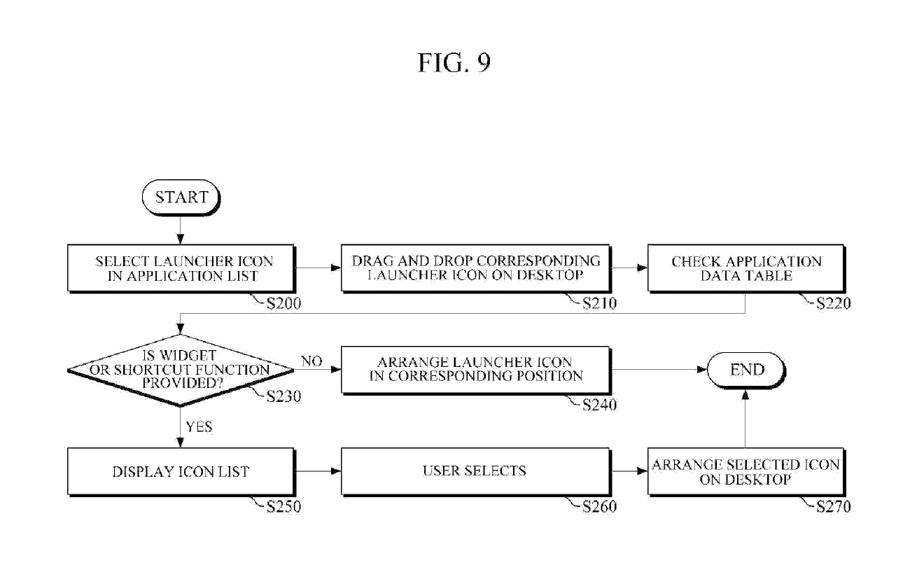

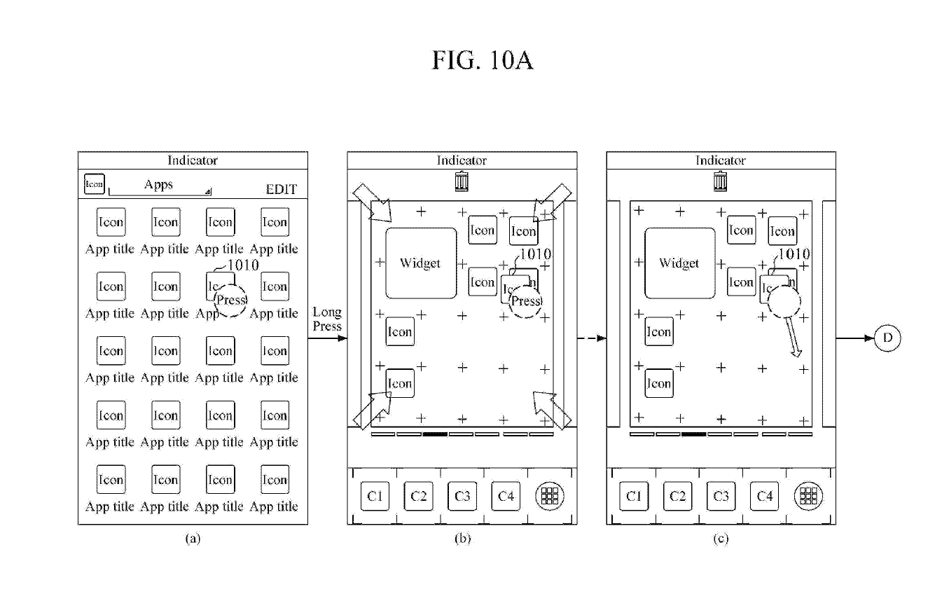

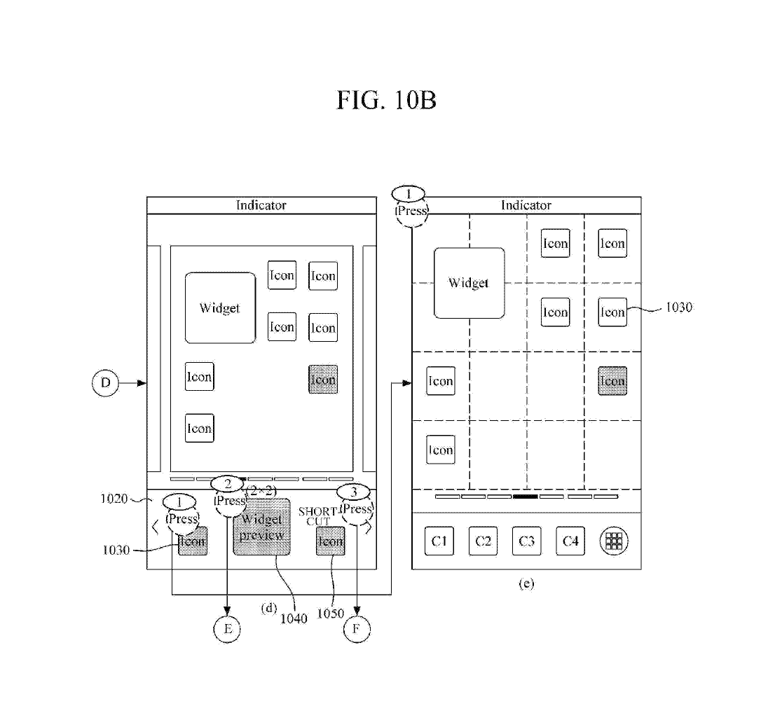

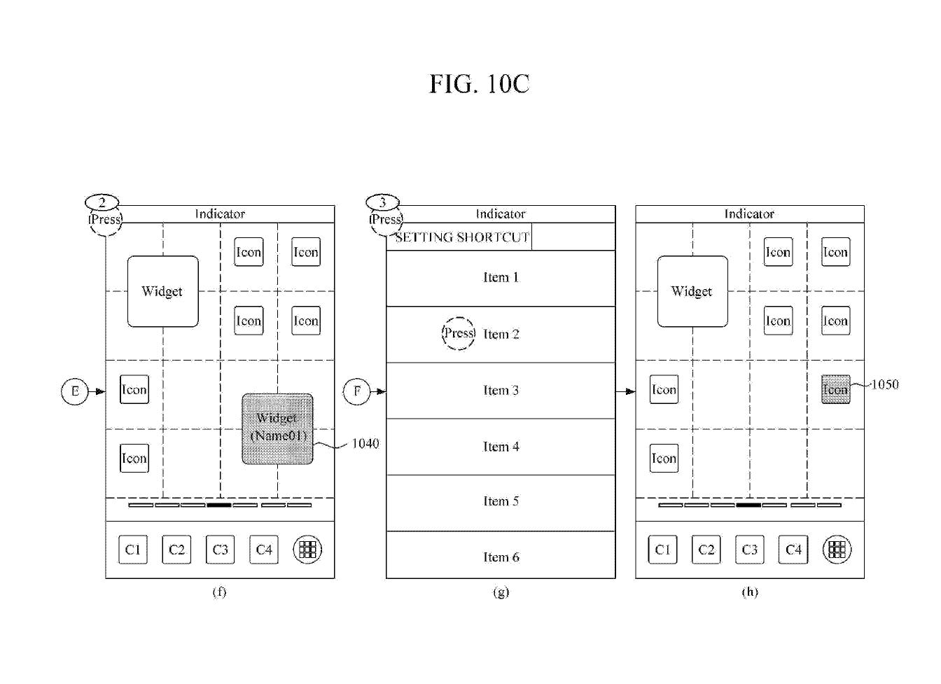

FIG. 9 illustrates a flowchart of graphic object arrangement according to exemplary embodiment of the invention. FIG. 10A, FIG. 10B and FIG. 10C illustrate a graphic object arrangement UI according to exemplary embodiments of the invention.

When the user selects a launcher icon of a desired application in the application list by a pressing and holding an icon 1010 as illustrated in screen (a) in FIG. 10A per operation S200 of FIG. 9, the controller 300 performs control such that the screen is switched to the desktop as illustrated in screen (b) in FIG. 10A and arranges the selected launcher icon 1010 on the desktop per operation S210 of FIG. 9. At this time, the user keeps pressing the launcher icon. When the user performs a drag-and-drop operation on the launcher icon 1010 to a desired position as illustrated in screen (c) in FIG. 10A, the controller 300 determines whether a widget or a shortcut function is provided for the corresponding application by checking the application data table per operations S220 and S230 of FIG. 9. When the widget or the shortcut function is not provided, the controller 300 arranges the launcher icon in the position in which it was dropped in screen (c) in FIG. 10A per operation S240 of FIG. 9.

When at least one or more widget or shortcut functions in addition to the launcher icon are provided, the controller 300 displays all graphic object lists according to attributes of corresponding applications. For example, the graphic object list is displayed on the tray by creating a tray 1020 as illustrated in screen (d) in FIG. 10B per operation S250 of FIG. 9. In this way, the user may select graphic objects to be arranged on the desktop among a launcher icon 1030, a widget or widget preview 1040, and a shortcut 1050 in the graphic object list per operation S260 of FIG. 9. The controller 300 arranges the graphic object selected in the graphic object list per operation S270 of FIG. 9. For example, when the user selects the launcher icon 1030, the controller 300 arranges the selected launcher icon 1030 on the desktop as illustrated in screen (e) in FIG. 10B. When the user selects the widget 1040, the controller 300 arranges the selected widget 1040 on the desktop as illustrated in screen (f) in FIG. 10C. When the user selects the shortcut 1050, the controller 300 displays an item list on the display unit 100 as illustrated in screen (g) in FIG. 10C and arranges the shortcut 1050 of the item selected by the user on the desktop as illustrated in screen (h) in FIG. 10C.

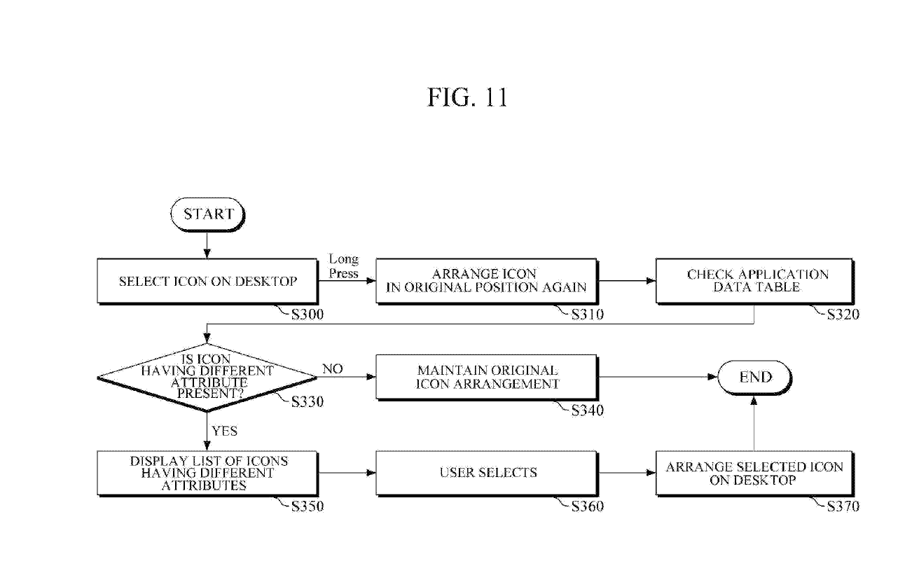

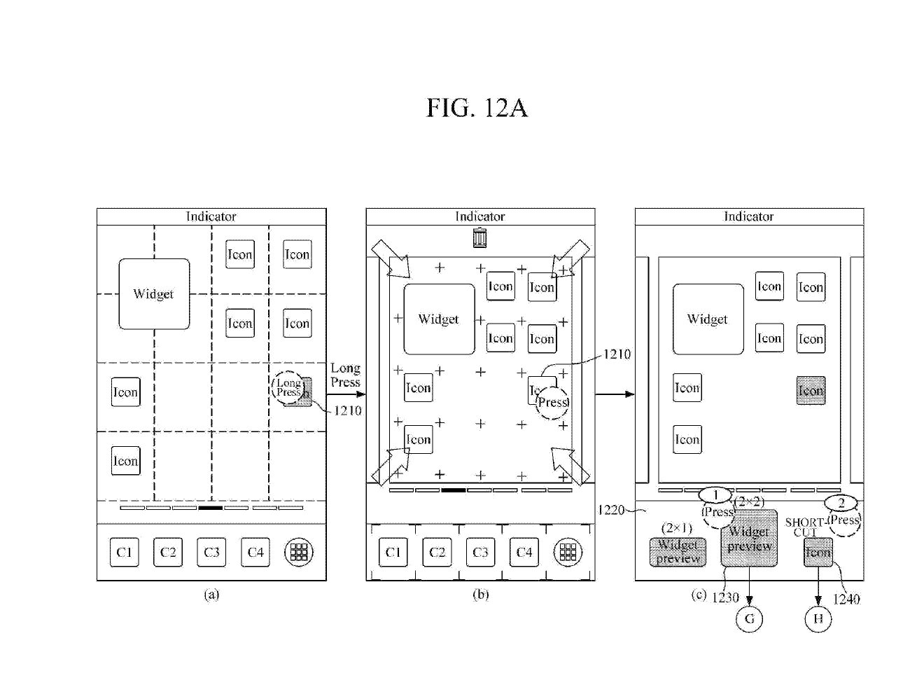

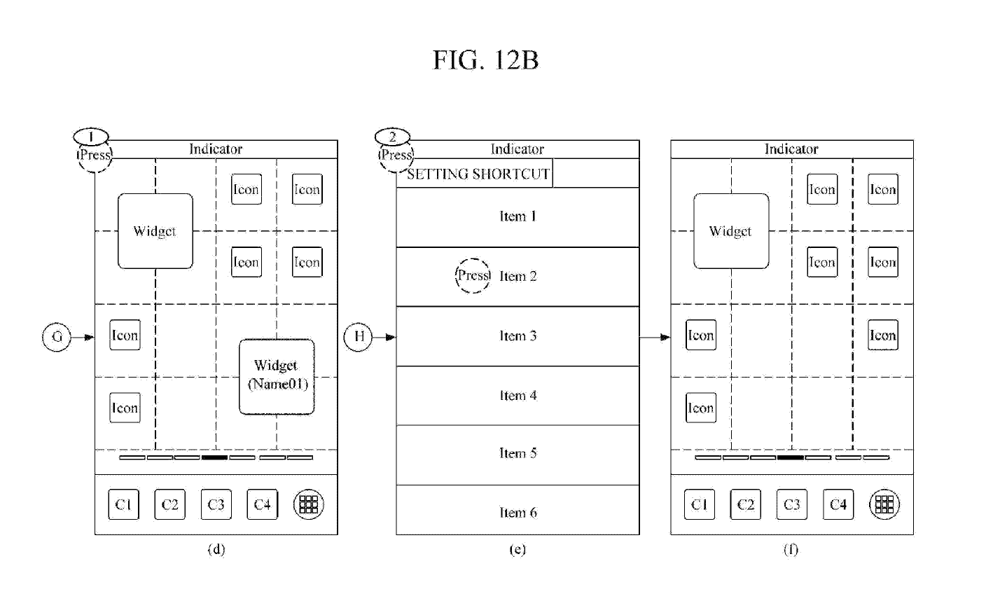

FIG. 11 illustrates a flowchart of graphic object replacement according to exemplary embodiments of the invention. FIG. 12A and FIG. 12B illustrate a graphic object replacement UI according to exemplary embodiments of the invention.

The controller 300 of FIG. 4 may replace the graphic object selected as a replacement target by the user in graphic objects arranged on the desktop with a graphic object having a different type or a different size. For example, the launcher icon may be replaced with the widget or the shortcut, and the widget may be replaced with a widget having a different size. For example, a 2×2 widget may be replaced with a 4×2 widget.

Hereinafter, the replacing manner of the graphic object will be described with reference to FIGS. 11, 12A, and 12B. The user selects the graphic object 1210 to be replaced on the desktop as illustrated in screen (a) in FIG. 12A. At this time, the replacement may be recognized by the controller 300. According to exemplary embodiments, the controller 300 determines whether the graphic object, that has been dragged and dropped according to the drag-and-drop manner with respect to graphic objects arranged on the desktop, is selected as a replacement target graphic object. According to exemplary embodiments, the controller 300 determines whether a graphic object in which a starting point and an ending point of the drag-and-drop operation of the graphic object arranged on the desktop are equal as a replacement target graphic object. That is, the user presses and holds the graphic object 1210 to be replaced in the graphic objects arranged on the desktop and makes it movable to another position as illustrated in screen (a) in FIG. 12A, and then releases the graphic object at that position again as illustrated in screen (b) in FIG. 12A, thereby replacing it with another graphic object per operations S300 and S310 of FIG. 11. Furthermore, it is possible to replace the graphic object using menus, for example, deletion, associated information, or attribute change.

When the graphic object 1210 is determined as the replacement target, the controller 300 determines whether graphic objects having different attributes are present in the corresponding application by checking the application data table per operations S320 and S330 of FIG. 11. Having a different attribute can include having a different graphic object type or having the same graphic object type with different sizes. Therefore, information on a size in addition to a type may be further included in Table 1. When no graphic objects having different attributes are present, the controller 300 maintains a desktop arrangement state of the original graphic object that is the replacement target graphic object per operation S340 of FIG. 11.

When graphic objects having different attributes are present, the controller 300 displays a list of the graphic objects having different attributes on the display unit 100, for example, displays them in a tray 1220 by creating the tray 1220 as illustrated in screen (c) in FIG. 12A per operation S350 of FIG. 11. Therefore, the user may select a desired graphic object having a different attribute per operation S360 and the controller 300 arranges the selected graphic object having a different attribute by replacing the replacement target graphic object with it on the desktop per operation S370. For example, the user selects a widget 1230 in screen (c) in FIG. 12A, and the controller 300 arranges the selected widget on the desktop as illustrated in screen (d) in FIG. 12B. When the user selects a shortcut 1240 in screen (c) in FIG. 12A from tray 1220, and the controller 300 displays an item list on the display unit 100 as illustrated in screen (e) in FIG. 12B and arranges the shortcut 1240 of the item selected by the user on the desktop as illustrated in (f) in FIG. 12B.

Aspects of the present invention provide a plurality of graphic objects of one application to be arranged on a desktop with one menu tree. As a result, user convenience for graphic object arrangement may be increased. For example, in a case in which a user wishes to arrange a launcher icon of a clock application on a desktop, when a widget of the clock application is present, the widget is displayed on a display unit, and accordingly, the widget may be easily arranged on the desktop.

In addition, aspects of the present invention provide that the graphic object already arranged on the desktop may be easily replaced with a graphic object having a different type or a different size.

Furthermore, aspects of the invention provide that the user is intuitively informed of the presence of all graphic objects provided from an application such that the presence of different types of graphic objects is displayed on an application list with respect to graphic objects having different types of graphic objects among graphic objects (for example, a launcher icon) belonging to the application list.

While the exemplary embodiments have been described above based on an ANDROID system, the invention is not limited thereto. The above-described methods may be applied in any operating system in which one application supports a plurality of graphic objects. While the invention has been described with reference to exemplary embodiments, it will be understood by those of skilled in the art that various changes in form and details may be made therein without departing from the spirit and scope of the present invention. Accordingly, disclosed exemplary embodiments should be considered in a descriptive sense only and not for purposes of limitation. Therefore, the scope of the invention is defined not by the detailed description of the invention but by the appended claims, and all differences within the scope will be construed as being included in the present invention.

Aspects of the present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method, utilizing a processor, for arranging a graphic object on a desktop, the method comprising:
disposing a launcher icon on a target position of the desktop;
checking, with the processor, an application data table to retrieve icons associated with an application;
selecting the launcher icon as a selected icon when the retrieved icons comprise a single icon and selecting one of the retrieved icons as a selected icon when the retrieved icons comprise a plurality of icons; and
arranging the selected icon in the target position.

2. The method of claim 1, further comprising installing the application.

3. The method of claim 1, wherein the selecting one of the retrieved icons comprises displaying the retrieved icons and receiving an indication of a selection of one of the retrieved icons.

4. The method of claim 3, wherein the target position is an original position of the launcher icon.

5. The method of claim 1, further comprising displaying an icon type with the selected icon.

6. The method of claim 1, wherein a size of the selected icon is not equal to a size of the target position, and the arranging comprises adjusting the desktop to dispose the selected icon at the target position.

7. The method of claim 1, wherein the application data table comprises an intent object.

8. The method of claim 1, further comprising selecting the launcher icon.

9. A smart device to arrange a graphic object on a desktop, the smart device comprising:
a storage comprising an application data table comprising icons associated with an application; and
a user interface configuring unit:
configured to dispose a launcher icon on a target position of the desktop,
configured to check an application data table to retrieve icons associated with an application,
configured to select the launcher icon as a selected icon when the retrieved icons comprise a single icon and configured to select one of the retrieved icons as a selected icon when the retrieved icons comprise a plurality of icons, and
configured to arrange the selected icon in the target position.

10. The smart device of claim 9, further comprising a package manager configured to install the application.

11. The smart device of claim 9, further comprising a display, and wherein the user interface configuring unit is configured to display the retrieved icons on the display and configured to receive an indication of a selection of one of the retrieved icons.

12. The smart device of claim 11, wherein the target position is an original position of the launcher icon.

13. The smart device of claim 9, further comprising a display, and wherein the user interface configuring unit is configured to display an icon type with the selected icon.

14. The smart device of claim 9, wherein a size of the selected icon is not equal to a size of the target position, and the user interface configuring unit is configured to adjust the desktop to dispose the selected icon at the target position.

15. The smart device of claim 9, wherein the application data table comprises an intent object.

16. The smart device of claim 9, wherein the user interface configuring unit is configured to receive a selection of a launcher icon of the application.
